(19) United States
(12) Patent Application Publication
(10) Pub. No.: US 2007/0020361 A1
(43) Pub. Date: Jan. 25, 2007

(54) Press-out pack for paste type strong flavor condiments

(76) Inventors: Chong Yun Yi, Fremont, CA (US); Myung Ok Back, Fremont, CA (US); Byung Hee Kim, Fremont, CA (US); Byoung Ha Kim, Fremont, CA (US)

Correspondence Address: Eugene Oak, 3064 Barrington Tettace, Fremont, CA, 94536, US

(21) Appl. No.: 11/188,084

(22) Filed: Jul. 25, 2005

(51) Int. Cl. A23B 7/148

(52) U.S. Cl. 426/106

(57) ABSTRACT

A press-out pack is provided for packing and storing a paste material of strong flavored condiments such as crushed garlic or the like. The pack comprises an accommodation body with plural storage recesses defined by sheet like portions for a containing paste material therein, a sealing lid, and a sealing sheet covering the crushed garlic in the recesses. The sealing sheet is made of a flexible transparent plastic such as LLDPE (Linear Low Density Polyethylene). The accommodation body is made of transparent and easily collapsible material such as PET (Poly Ethylene There-phthalate). The sealing lid is made of soft plastic material with proper stiffness such as homo- and copolymer of PP (Polypropylene). The sealing lid of the current application has groove for airtight sealing that fits to the perimeter of the three sides of the upper brim of the accommodation body and has an opening for easy sliding of the front side of the lid.

### BACKGROUND OF THE INVENTION

Various kinds of condiments with strong flavor are used for delicious cuisine. garlic, red pepper, ginger, onion, and green onion are most common condiments. Among them garlic is the most favored condiment chosen by many gourmet like to add to their servings. In most cases the garlic is crushed and ground in a paste form for an easy dispersion into the food. However, the irritating odor from the garlic, while crushing, is too strong for average people. Therefore, many kinds of pre- ground or crushed Gallic pastes are stocked in super markets. Most of the garlic pastes are packed in a glass jar or in a small plastic container with tight sealing. Occasionally, the metal lid of a jar is jammed to the screw developed on the neck of the container jar if the container is not opened for a long time. It may need unnecessary effort just to open the lid. Even after the lid is removed, a cooking person needs a spoon or scooper to take out the garlic paste from the container. Then another kitchen utensil should be cleaned after cooking.

1. Field of the Invention

The present invention generally relates to an individual press through packing for strong flavor condiments, especially relates to sliding lid covered press packing.

2. Description of the Prior Art

U.S. Pat. No. 6,637,596 and U.S. patent application No. 20040060845 to Ito, et al. illustrate a press-through pack and a sealing sheet for use in the same capable of easily taking out solid material such as tablet or the like contained storage recesses by only pushing action of fingers. The pack comprises an accommodation body with plural storage recesses defined by sheet like portions for a containing solid material therein and sealing sheet.

U.S. Pat. No. 6,540,081 to Balz, et al. illustrates a reusable dispenser (10) for dispensing a unit dose of a solid product contained in a disposable blister pack (25). The dispenser (10) includes a housing (11), a back plate (30), and a dispensing tray (40). The blister pack (25) containing product is positioned between the housing (11) and the back plate (30), and the product is dispensed through the back plate (30) into the dispensing tray (40) where it can be acquired for use.

U.S. Pat. No. 6,375,956 to Hermelin, et al. illustrates a disposable dispensing apparatus which provides optimal therapeutic support to humans and other animals by conveniently supplying a complex dosing regimen requiring simultaneous administration of storage-incompatible or unevenly dosed components in a shelf stable user-friendly format.

U.S. Pat. No. 5,393,032 to Cederroth illustrates an ice tray that includes a body and a laminated cover that has a plastic coat for securing together the body and the cover. The body includes a plurality of individual cavities for receiving liquid therein. Each wall of each cavity has an upper edge that forms a lip. The cover is sealed along each lip of each cavity to provide a liquid tight seal for each cavity. The body and cover are each, preferably, formed of a single sheet of material. The body is made of pure polyvinyl chloride plastic, and the cover is made of a laminate of polyester and polyamide with adhesive there between and the plastic coat on the side of the polyester opposite the adhesive.

None of the prior art illustrates a press-out pack fit for storing and easily releasing a paste form of strong flavored condiments.

### SUMMARY OF THE INVENTION

To avoid the intricate step of crushing strong flavor condiments into paste form and scoop out them with another kitchen utensil to be washed later, a press-through pack is provided for packing and storing a paste material such as crushed gallic or the like. The pack comprises an accommodation body with plural storage recesses defined by sheet like portions for a containing paste material therein, a sliding sealing lid, and a sealing sheet covering the crushed Garlic in the recesses. The sealing sheet is made of a flexible transparent plastic such as LLDPE (Linear Low Density Polyethylene). The sealing lid is made of soft plastic material with proper stiffness such as homo- and copolymer of PP (Polypropylene). The accommodation body is made of transparent and easily collapsible material such as PET (Poly Ethylene Therephthalate). The accommodation body has three to five rows of eight to twenty recesses of half- egg shape pocket. The sliding sealing lid of the current application has groove for airtight sealing that fits to the perimeter of the three sides of the upper brim of the accommodation body and has an opening on the front side of the lid. Another embodiment of the current application is a lid having grooves for airtight sealing along the projection developed along the perimeter of the upper brim of the accommodation body.

### BRIEF DESCRIPTION OF THE OF THE DRAWINGS

FIG. 1 is a perspective view of a press-out pack for paste type strong flavor condiments in accordance with the current application.

FIG. 2 is a side view of the press-out pack for paste type strong flavor condiments in accordance with the invention.

FIG. 3 is an over view of the accommodation body of the press-out pack for paste type strong flavor condiments in accordance with the invention.

FIG. 4 is a frontal side view of the lid of the press-out pack for paste type strong flavor condiments in accordance with the invention.

FIG. 5 is a bottom view of the lid of the press-out pack for paste type strong flavor condiments in accordance with the invention.

FIG. 6 is a schematic diagram showing how to use the press-out pack for paste type strong flavor condiments in accordance with the invention.

### DETAILED DESCRIPTION OF THE PREFERRED EMBODIMENT

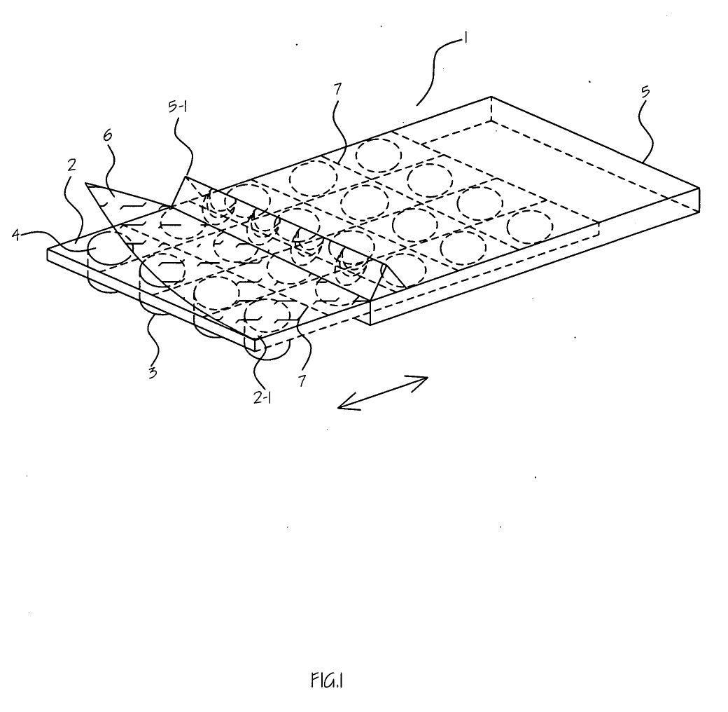

FIG. 1 is a perspective view of a press-out pack (1) for paste type strong flavor condiments in accordance with the invention. The pack (1) is comprised of an accommodation body (2) with plural storage recesses (3) defined by sheet like portions for a containing paste material (4) therein, a sliding sealing lid (5), and a flexible transparent sheet (6) covering the paste material (4) in the recesses (3). The flexible transparent covering sheet (6) is adhered to the accommodation body (2) along the edges (2-1) thereof and has perforated stitch marks (7) to isolate a desired portion from the left part of the covering sheet. That is to minimize the exposure of the strong flavored condiments (4) to the air when a user tries to take out two or three pieces of them from the recesses (2). A user only needs to tear out needed pieces of the perforated covering sheet (6).

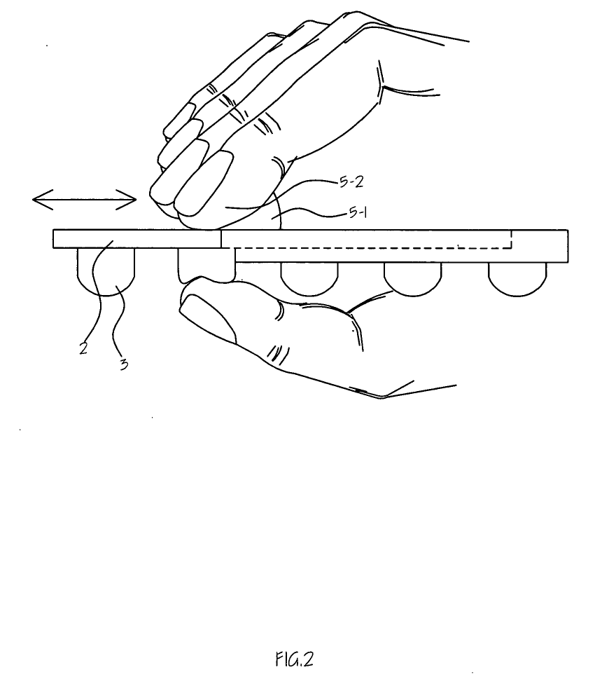

FIG. 2 is a side view of the press-out pack (1) for paste type strong flavor condiments in accordance with the invention. The lid (5) has a projected portion (5-1) at the front end thereof. The projected portion (5-1) is formed to fit to finger tips (5-2) of the user to make it easy to slide the lid (5) and open the press-out pack (1). Inside of the projected portion (5-1), pluralities of grooves (5-3) are developed to prevent the user's fingers from slipping out of the portion (5-1) due to the slippery moistures developing when the press-out pack (1) comes out from a refrigerator, wherein the pack (1) is stored.

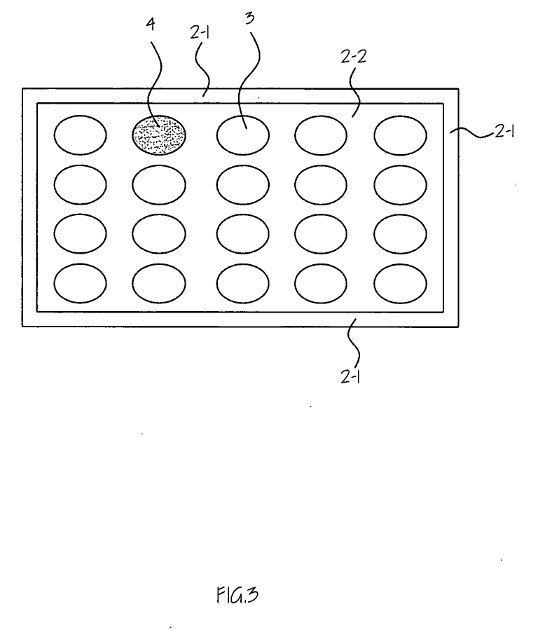

FIG. 3 is the over view of the accommodation body (2) of the press-out pack (1) for paste type strong flavor condiments in accordance with the invention. Most of ground condiments, ground garlic for example, are kept in a refrigerator at a temperature between 0 to 5° C. to prevent deterioration. At this temperature the paste has high viscosity and therefore sticky. The recesses (3) are developed in a half sphere shape to minimize the frictional resistance due to the stickiness of the paste materials (4) in the recesses when they are pushed out. About four by five arrays of recesses (3) of 2 cm diameter are developed per one accommodation body (2). The accommodation body (2) is made of PET (Poly Ethylene Therephthalate) for transparency and stiffness of the body. The thickness of the upper plate (2-2) of the accommodation body is 0.3 mm and the thickness of the recesses (3) is 0.1 mm. The upper plate (2-2) is designed to hold stiffness strong enough to sustain the pressure for pressing the recesses (3). Meanwhile, the recesses (3) are form in very thin sheet form of 0.2 mm for easy deformation by slight pressing.

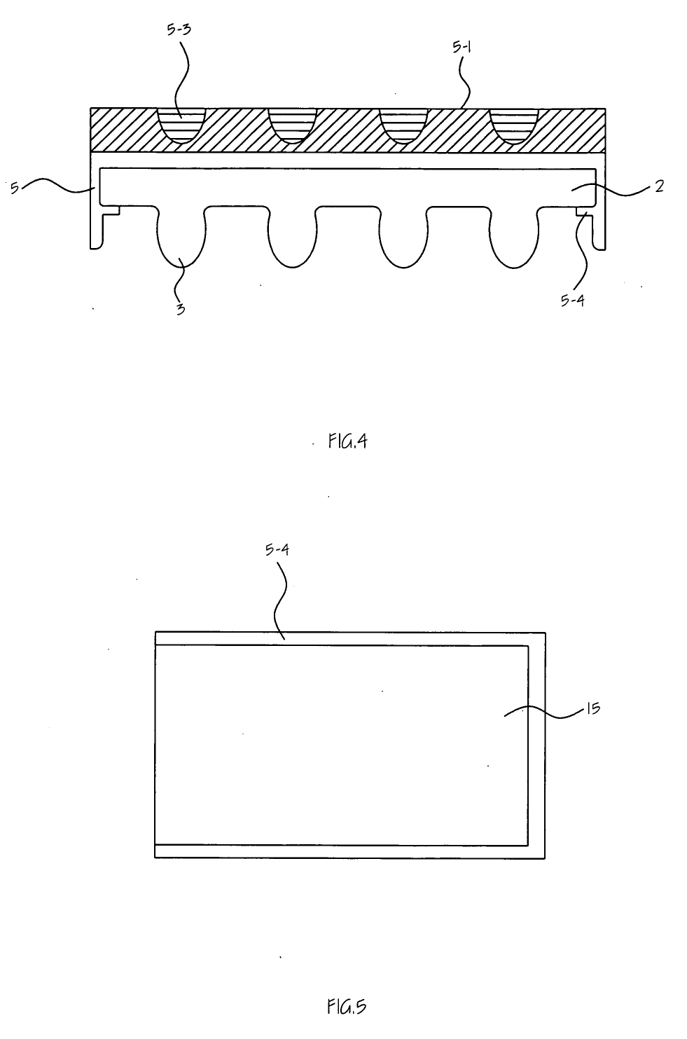

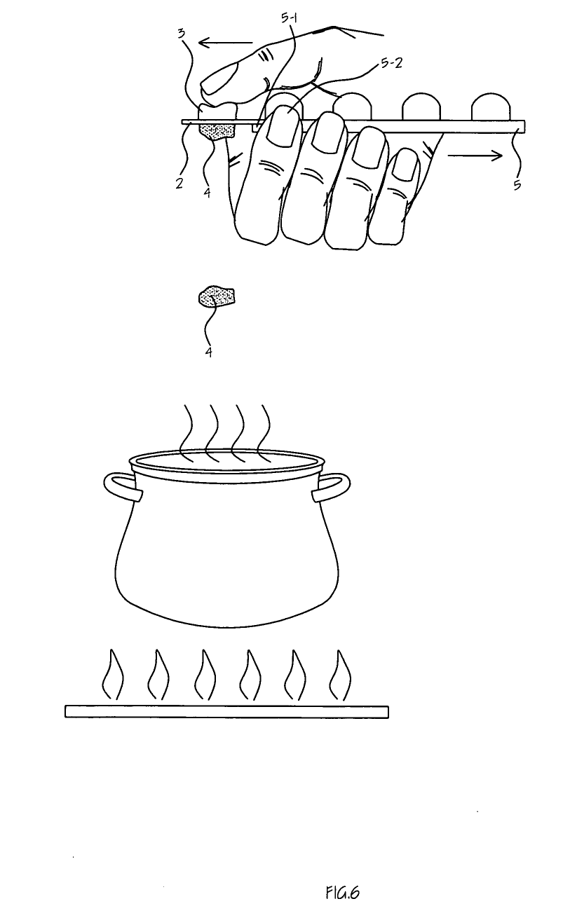

FIG. 4 is a frontal side view of the lid (5) of the press-out pack for paste type strong flavor condiments in accordance with the invention. And FIG. 5 is a bottom view of the lid (5). The lid (5) is made of, including but not limited to, blended polymer of LD (Low Density)/LLDPE (Linear Low Density Poly-ethylene), homo-, and copolymer of PP (Poly-propylene). A groove (54) for receiving the three edges (2-1) of the accommodation body (2) is developed along the three edges of the lid (5). FIG. 6 shows how to pick out the crushed garlic paste (4) from the recess (3). Open the lid (5) with fingers (5-2). Tear out needed piece of covering sheet (6) along the perforated stitch mark (7). Then press a recess (3) with other finger. The garlic plaste (4) will be put into the pot (8) where a food is being cooked.

What is claimed is:

1. A press-out pack, for packing and storing a paste material of strong flavored condiments such as crushed gallic or the like, comprised of an accommodation body made from poly ethylene therephthalate with plural storage recesses defined by sheet like portions of 0.2 mm thickness for containing paste material of strong flavored condiments therein and a sliding sealing lid, made of polypropylene, having groove for air tight sealing and sliding along the projection developed along the three phases of the perimeter of the upper brim of the accommodation body.

2. The press-out pack of the claim 1, wherein a projected portion, formed to fit to finger tips of a user, is developed along the front edge of the upper surface of the sliding sealing lid.

3. The press-out pack of the claim 1, wherein the condiment is crushed gallic.

4. The press-out pack of the claim 1, wherein the condiment is crushed ginger.
